(19) United States
(12) Patent Application Publication
(10) Pub. No.: US 2025/0233336 A1
(43) Pub. Date: Jul. 17, 2025

(54) Terminal Assembly and Related Methods

(71) Applicant: Aptiv Technologies AG, Schaffhausen (CH)

(72) Inventors: Joseph Cachina, Warwick, RI (US); David Martins, Fall River, MA (US); Hugo Alberto Perez, Monterrey (MX)

(21) Appl. No.: 18/962,619

(22) Filed: Nov. 27, 2024

Related U.S. Application Data
(60) Provisional application No. 63/620,203, filed on Jan. 12, 2024.

(51) Int. Cl. H01R 13/20; H01R 43/26

(52) U.S. Cl. CPC H01R 13/20; H01R 43/26; H01R 2201/26

(57) ABSTRACT

A terminal assembly includes a male terminal and a female terminal. The male terminal includes a first base and a protrusion extending from the first base. The protrusion defines an oblong shape. The female terminal includes a second base and a plurality of projections extending from the second base. The second base defines a void configured to receive the protrusion. The plurality of projections are disposed around the void and collectively define an oblong shape. In an assembled configuration, the protrusion engages the plurality of projections such that the male terminal is connected with the female terminal.

### CROSS-REFERENCE TO RELATED APPLICATIONS

This application claims the benefit of U.S. Provisional Application No. 63/620,203 filed Jan. 12, 2024, the entire disclosure of which is incorporated

### FIELD

The present disclosure relates to a terminal assembly and more particularly to a terminal assembly having an oblong male terminal and an oblong female terminal.

### BACKGROUND

Modern vehicles (for example, automobiles) rely on electrical wiring and electrical connections to facilitate communication between various electronic components within the vehicle. Connection systems (for example, connectors and terminals) play an important role in ensuring the integrity of these electrical connections and the reliability and performance of the vehicle. Some connection systems include a male terminal and a female terminal. In some situations, it is desirable to secure the male terminal with the female terminal such that the male terminal is electrically connected with the female terminal. During extended use of certain connection systems, the connection between the male terminal and the female terminal may become loose such that the female terminal may move excessively relative to the male terminal. This may result in a weak electrical connection or a loss in electrical connection between the male terminal and the female terminal. In view of the foregoing, while current connection systems have proven acceptable for their intended purpose, a continuous need for improvement remains in the pertinent art to address the challenges associated with ensuring a secure connection between mating terminals.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect of the disclosure provides a terminal assembly. The terminal assembly includes a male terminal and a female terminal. The male terminal includes a first base and a protrusion extending from the first base. The protrusion defines an oblong shape. The female terminal includes a second base and a plurality of projections extending from the second base. The second base defines a void configured to receive the protrusion. The plurality of projections are disposed around the void and collectively define an oblong shape. In an assembled configuration, the protrusion engages the plurality of projections such that the male terminal is connected with the female terminal.

Another aspect of the disclosure provides a method of assembling a terminal assembly. The method includes disposing at least a portion of a protrusion of a male terminal in a void of a female terminal. The protrusion defines an oblong shape. A base of the female terminal defines the void. The method also includes engaging a plurality of projections of the female terminal with the protrusion. The plurality of projections are disposed around the void and collectively define an oblong shape. In an assembled configuration, the male terminal is electrically connected with the female terminal.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a perspective view of an example terminal assembly in accordance with the principles of the present disclosure.

FIG. 2 is a schematic view of an example terminal assembly in accordance with the principles of the present disclosure.

FIG. 3 is a perspective view of an example male terminal of a terminal assembly in accordance with the principles of the present disclosure.

FIG. 4 is a top view of an example protruding portion of a male terminal in accordance with the principles of the present disclosure.

FIG. 5 is a perspective view of an example female terminal of a terminal assembly in accordance with the principles of the present disclosure.

FIG. 6 is a top view of an example female terminal of a terminal assembly in accordance with the principles of the present disclosure.

FIG. 7 is a flowchart depicting an example method for assembling a terminal assembly in accordance with the principles of the present disclosure.

In the drawings, reference numbers may be reused to identify similar and/or identical elements.

### DETAILED DESCRIPTION

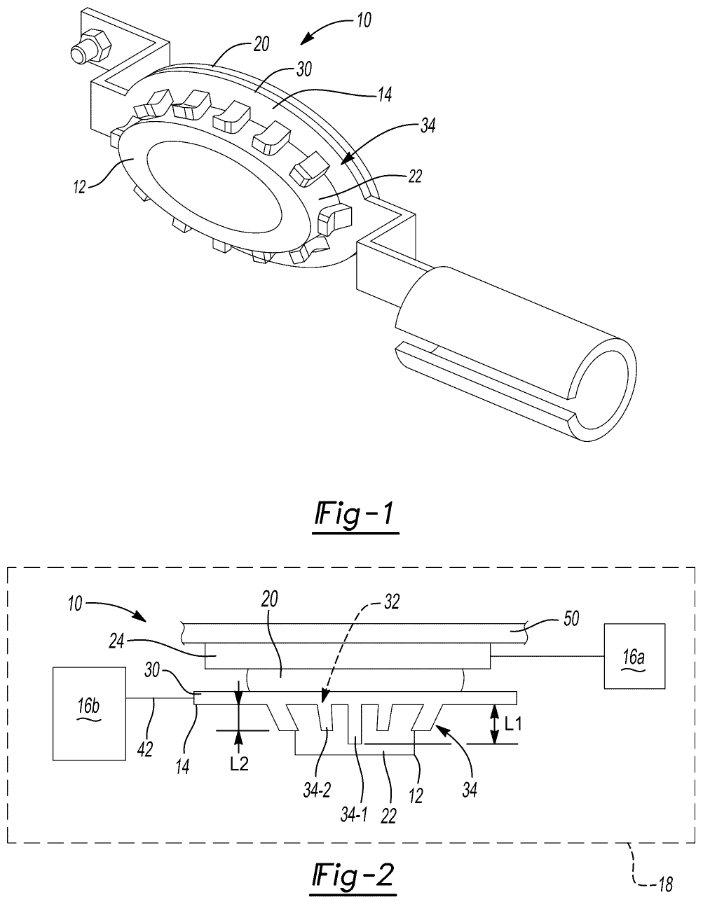

With reference to FIGS. 1 and 2, a terminal assembly 10 is shown. The terminal assembly 10 may include a male terminal 12 and a female terminal 14. The male terminal 12 mates with the female terminal 14 such that in an assembled configuration the male terminal 12 is electrically connected with the female terminal 14. The male terminal 12 connects, at least indirectly, with an electrical component 16a and the female terminal 14 connects, at least indirectly with an additional electrical component 16b. In the assembled configuration, the male terminal 12 is connected with the female terminal 14 such that the electrical component 16a is electrically connected with the additional electrical component 16b.

With continued reference to FIGS. 1 and 2, in various implementations, the terminal assembly 10 may be installed in a vehicle 18 to facilitate the transmission of electricity and/or the transmission of signals (for example, control signals) between various electronic components (for example, electrical components 16a, 16b) within the vehicle 18. The vehicle 18 may include one or more of a variety of configurations. For example, the vehicle 18 may include a land vehicle, a passenger car, a van, a sport utility vehicle (SUV), a crossover, a truck (for example, a pickup truck, a commercial truck, etc.), a bus, a watercraft, an aircraft (for example, a plane, a helicopter, etc.), and/or a combination thereof (for example, a vehicle for land and water, a vehicle for air and water, etc.), among others. While the vehicle 18 is shown and described herein including one terminal assembly 10, it will be appreciated that the vehicle 18 may include more than one terminal assembly 10. In some examples, the vehicle 18 may include a plurality of terminal assemblies 10.

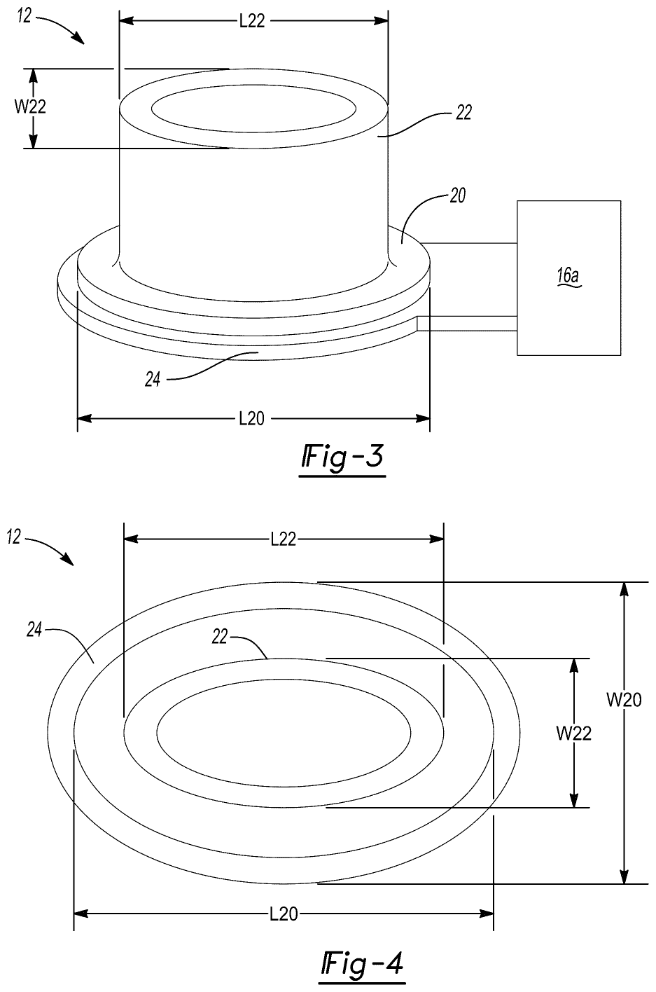

With reference to FIGS. 3 and 4, the male terminal 12 may include a base 20 and a protrusion 22 extending from the base 20. In various implementations, the base 20 forms an oblong-shaped configuration. For example, an outer (for example, peripheral) surface of the base 20 may define an ellipse-shaped or oval-shaped configuration. The base 20 may include a width W20 and a length L20 that is greater than the width W20. Alternatively, the base 20 may include a width W20 that is greater than its length L20. In some examples, the base 20 may define a width-to-length ratio of approximately 6:9 or 4:3, among others. The base 20 may include a substantially planar upper surface.

In various implementations, the base 20 may be coupled to an electrical contact 24. The electrical contact 24 comprises one or more conductive materials. The base 20 may be secured to the electrical contact 24 via a soldering process, a reflow process, a heat press process, or a brass clad process, among others. In the assembled configuration, the electrical contact 24 is electrically connected with the electrical component 16a such that the male terminal 12 is electrically connected with the electrical component 16a.

In various implementations, the protrusion 22 forms an oblong-shaped configuration. For example, an outer (for example, peripheral) surface of the protrusion 22 may define an ellipse-shape or oval-shape protruding from the base 20 (for example, from the upper surface of the base 20). In other implementations, the protrusion 22 may form a stadium shape. While the protrusion 22 is generally illustrated as forming a hollow construct, it will be appreciated that the protrusion 22 may form a solid construct within the scope of the present disclosure.

The protrusion 22 may include a width W22 and a length L22 that is greater than the width W22. Alternatively, the protrusion 22 may include a width W22 that is greater than its length L22. In some examples, the protrusion 22 may define a width-to-length ratio of approximately 6:9 or 4:3, among others. As will be explained in more detail below, in an assembled configuration (for example, FIG. 1), the protrusion 22 connects with the female terminal 14.

In various implementations, the male terminal 12 comprises one or more conductive materials. For example, the male terminal 12 may comprise one or more metals and/or one or more conductive plastics, among others. In some examples, the male terminal 12 may be manufactured via a metal stamping process.

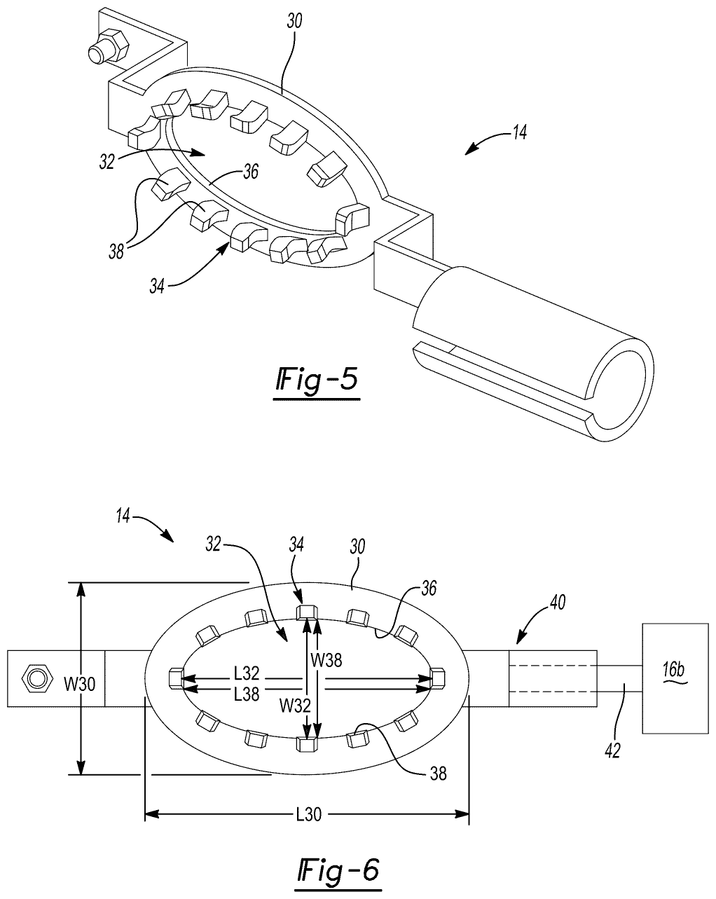

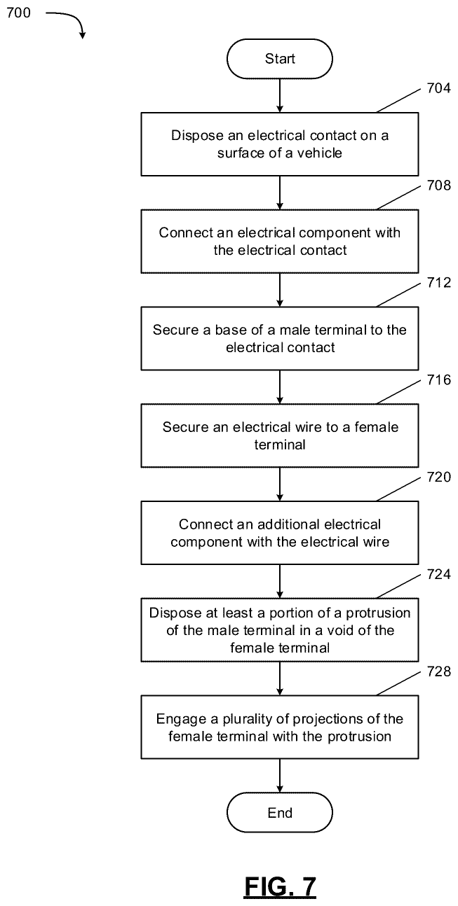

With reference to FIGS. 5 and 6, the female terminal 14 may include a base 30, a void 32 disposed in the base 30, and a plurality of projections 34 extending from the base 30 and disposed around the void 32. In various implementations, the base 30 forms an oblong-shaped configuration. For example, an outer (for example, peripheral) surface of the base 30 may define an ellipse-shaped or oval-shaped configuration. The base 30 may include a width W30 and a length L30 that is greater than the width W30. Alternatively, the base 30 may include a width W30 that is greater than its length L30. In some examples the base 30 may include a width-to-length ratio of approximately 6:9 or 4:3, among others. An upper surface of the base 30 may be substantially planar.

In various implementations, the void 32 is defined by an oblong-shaped inner (for example, peripheral) surface 36 of the base 30. For example, the inner (for example, peripheral) surface 36 of the base 30 may define an ellipse-shape or oval-shape. In other implementations, the inner surface 36 of the base 30 defines a stadium shape.

The void 32 may define a width W32 and a length L32 that is greater than the width W32. Alternatively, the void 32 may define a width W32 that is greater than its length L32. In some examples the void 32 may define a width-to-length ratio of approximately 6:9 or 4:3, among others. As will be explained in more detail below, in the assembled configuration (for example, FIG. 1), the void 32 receives at least a portion of the protrusion 22 of the male terminal 12.

In various implementations, the projections 34 may be disposed about the void 32 to collectively form an oblong-shaped configuration. For example, inner (for example, peripheral) surfaces 38 of the projections 34 may collectively define an ellipse-shape or oval-shape. In other implementations, the inner surfaces 38 of the projections 34 collectively define a stadium shape. A first plurality (for example, two) of the inner surfaces 38 may define a width W38, and a second plurality (for example, two) of the inner surfaces 38 may define a length L38 that is greater than the width W38. Alternatively, the width W38 may be greater than the length L38. In some examples, a ratio of the width W38 to the length L38 is approximately 6:9 or 4:3, among others. In some implementations, the length L38 is substantially equal to the length L32, and the width W38 is substantially equal to the width W32. In other implementations, the length L38 is less than the length L32, and the width W38 is less than the width W32.

In the assembled configuration (for example, FIG. 1), the projections 34 (for example, the inner surfaces 38) engage the protrusion 22 of the male terminal 12. While the female terminal 14 is shown herein including twelve projections 34, it will be appreciated that the female terminal 14 may include more or less than twelve projections 34. In some example configurations, the female terminal 14 includes eight projections 34. In some instances, the female terminal 14 includes six projections 34.

With reference to FIG. 2, the projections 34 may define various lengths. For example, a first projection 34-1 may define a first length L1, and a second projection 34-2 may define a second length L2 that is less than the first length L1. In some example configurations, approximately half of the projections 34 define lengths that are substantially (for example, +/−10%) similar to the first length L1 and approximately half of the projections define lengths that are substantially (for example, +/−10%) similar to the second length L2. In some examples, every other projection of the plurality of projections 34 define the first length L1 such that a projection 34 defining the second length L2 is disposed between two projections 34 defining the first length L1.

In various implementations, the female terminal 14 comprises one or more conductive materials. For example, the female terminal 14 may comprise one or more metals and/or one or more conductive plastics, among others.

Referring now to FIG. 6, the female terminal 14 may include a connection portion 40. The connection portion 40 may be connected to and/or may extend from the base 30. The connection portion 40 connects with at least one electrical wire 42. In various implementations, the electrical wire 42 may be secured to the connection portion 40 via crimping or soldering, among others. In the assembled configuration, the electrical wire 42 is electrically connected with the additional electrical component 16b such that the female terminal 14 is electrically connected with the additional electrical component 16b.

In various implementations, an electrical component (for example, electrical components 16a, 16b) includes one or more of a variety of configurations. For example, an electrical component may include an electrical device, an electrical component of the vehicle 18, and/or an electronics device, among others. In some examples, the electrical component 16a may include an electrical component of the vehicle 18 such as an antenna or a window defroster, among others. The additional electrical component 16b may include an electrical component of the vehicle 18 such as a radio, a telephone, or a window defroster controller, among others.

Referring now to FIG. 2, in the assembled configuration, the male terminal 12 is electrically connected with the electrical contact 24 and the electrical component 16a. The female terminal 14 is electrically connected with the electrical wire 42 and the additional electrical component 16b. The male terminal 12 is connected with the female terminal 14 such that the electrical component 16a is electrically connected with the additional electrical component 16b.

In various implementations, at least a portion of the protrusion 22 of the male terminal 12 is disposed in the void 32 of the female terminal 14. The protrusion 22 is in contact with the projections 34 of the female terminal 14 and the base 20 of the male terminal 12 is in contact with the base 30 of the female terminal 14 such that the male terminal 12 is electrically connected with the female terminal 14. The oblong shape collectively defined by the projections 34, the oblong shape defined by the inner surface 36, and/or the oblong shape defined by the protrusion 22 restrict the female terminal 14 from moving (for example, rotating) relative to the male terminal 12 thereby forming a robust electrical connection between the female terminal 14 and the male terminal 12. The lengths (for example, the first length L1 and the second length L2) of the projections 34 restrict the female terminal 14 from moving (for example, rotating about an axis extending in a direction of L1 and/or translating in a direction of L1) relative to the male terminal 12 thereby forming a robust electrical connection between the female terminal 14 and the male terminal 12.

In various implementations, the electrical contact 24 is connected with a surface 50 of the vehicle 18. The surface 50 may include a glass surface such as a window or a windshield of the vehicle 18. In various implementations, the terminal assembly 10 may be disposed in a housing (not shown). In some example configurations, the terminal assembly 10 may be encapsulated by a molding process.

FIG. 7 is a flowchart of an example method 700 for assembling a terminal assembly 10. Control begins at 704. At 704, a user may dispose an electrical contact 24 on a surface 50 of a vehicle 18. Control proceeds to 708. At 708, a user may connect an electrical component 16a with the electrical contact 24. Control proceeds to 712.

At 712, a user may secure a base 20 of a male terminal 12 to the electrical contact 24 such that the male terminal 12 is electrically connected with the electrical component 16a. Control proceeds to 716. At 716, a user may secure at least one electrical wire 42 to a female terminal 14. Control proceeds to 720. At 720, a user may connect an additional electrical component 16b with the electrical wire 42 such that the female terminal 14 is electrically connected with the additional electrical component 16b. Control proceeds to 724.

At 724, a user may dispose at least a portion of a protrusion 22 of the male terminal 12 in a void 32 of the female terminal 14. Control proceeds to 728. At 728, a user may engage a plurality of projections 34 of the female terminal 14 with the protrusion 22 such that the male terminal 12 is connected with the female terminal 14 and the electrical component 16a is electrically connected with the additional electrical component 16b. Then control ends.

The following Clauses provide an exemplary configuration for a terminal assembly and related methods, as described above.
Clause 1: A terminal assembly comprising: a male terminal including a first base and a protrusion extending from the first base and defining an oblong shape; and a female terminal including a second base and a plurality of projections extending from the second base, the second base defining a void configured to receive the protrusion, the plurality of projections disposed around the void and collectively defining an oblong shape, the protrusion engaging the plurality of projections in an assembled configuration such that the male terminal is connected with the female terminal.
Clause 2: The terminal assembly of clause 1 wherein the first base defines an oblong shape.
Clause 3: The terminal assembly of any of clauses 1 through 2 wherein the second base defines an oblong shape.
Clause 4: The terminal assembly of any of clauses 1 through 3 wherein the female terminal includes an inner surface defining the void having an oblong shape.
Clause 5: The terminal assembly of any of clauses 1 through wherein: a first projection of the plurality of projections defines a first length; a second projection of the plurality of projections defines a second length; and the second length is less than the first length.
Clause 6: The terminal assembly of any of clauses 1 through 5 wherein, in the assembled configuration, the male terminal is connected with the female terminal such that the plurality of projections restrict the female terminal from moving relative to the male terminal.
Clause 7: The terminal assembly of any of clauses 1 through 6 wherein: the first base is configured for connection with an electrical contact; the electrical contact is configured for connection with an electrical component; and in the assembled configuration, the male terminal is electrically connected with the electrical component.
Clause 8: The terminal assembly of clause 7 wherein: the female terminal includes a connection portion connected to the second base and configured for connection with an electrical wire; and in the assembled configuration: the electrical wire is electrically connected with an additional electrical component, and the male terminal is connected with the female terminal such that the electrical component is electrically connected with the additional electrical component.
Clause 9: The terminal assembly of any of clauses 1 through 8 wherein the oblong shape collectively defined by the plurality of projections is an oval.
Clause 10: A vehicle comprising: the terminal assembly of any of clauses 1 through 9; an electrical component electrically connected with the male terminal; and an additional electrical component electrically connected with the female terminal, wherein, in the assembled configuration, the male terminal is connected with the female terminal such that the electrical component is electrically connected with the additional electrical component.
Clause 11: A method of assembling a terminal assembly, the method comprising: disposing at least a portion of a protrusion of a male terminal in a void of a female terminal, the protrusion defining an oblong shape, and a base of the female terminal defining the void; and engaging a plurality of projections of the female terminal with the protrusion such that the male terminal is electrically connected with the female terminal in an assembled configuration and the plurality of projections are disposed around the void and collectively define an oblong shape.
Clause 12: The method of clause 11 wherein a base of the male terminal defines an oblong shape.
Clause 13: The method of any of clauses 11 through 12 wherein the base of the female terminal defines an oblong shape.
Clause 14: The method of any of clauses 11 through 13 wherein the female terminal includes an inner surface defining the void having an oblong shape.
Clause 15: The method of any of clauses 11 through 14 wherein: a first projection of the plurality of projections defines a first length; a second projection of the plurality of projections defines a second length; and the second length is less than the first length.
Clause 16: The method of any of clauses 11 through 15 wherein, in the assembled configuration, the male terminal is connected with the female terminal such that the plurality of projections restrict the female terminal from moving relative to the male terminal.
Clause 17: The method of any of clauses 11 through 16 wherein: a base of the male terminal is configured for connection with an electrical contact; the electrical contact is configured for connection with an electrical component; and in the assembled configuration, the male terminal is electrically connected with the electrical component.
Clause 18: The method of clause 17 wherein: the female terminal includes a connection portion connected to the base of the female terminal and configured for connection with an electrical wire; and in the assembled configuration: the electrical wire is electrically connected with an additional electrical component, and the male terminal is connected with the female terminal such that the electrical component is electrically connected with the additional electrical component.
Clause 19: The method of any of clauses 11 through 18: wherein the oblong shape collectively defined by the plurality of projections is an oval.
Clause 20: The method of any of clauses 11 through 19 further comprising: disposing an electrical contact on a glass surface of a vehicle; connecting an electrical component with the electrical contact; and securing a base of the male terminal to the electrical contact, wherein in the assembled configuration the male terminal is electrically connected with the electrical component.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

Spatial and functional relationships between elements (for example, between modules, circuit elements, semiconductor layers, etc.) are described using various terms, including “connected,” “engaged,” “coupled,” “adjacent,” “proximate,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “set” does not necessarily exclude the empty set—in other words, in some circumstances a “set” may have zero elements. The term “non-empty set” may be used to indicate exclusion of the empty set—in other words, a non-empty set will always have one or more elements. The term “subset” does not necessarily require a proper subset. In other words, a “subset” of a first set may be coextensive with (equal to) the first set. Further, the term “subset” does not necessarily exclude the empty set—in some circumstances a “subset” may have zero elements.

The terms first, second, third, etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

What is claimed is:

1. A terminal assembly comprising:
a male terminal including a first base and a protrusion extending from the first base and defining an oblong shape; and
a female terminal including a second base and a plurality of projections extending from the second base, the second base defining a void configured to receive the protrusion, the plurality of projections disposed around the void and collectively defining an oblong shape, the protrusion engaging the plurality of projections in an assembled configuration such that the male terminal is connected with the female terminal.

2. The terminal assembly of claim 1 wherein the first base defines an oblong shape.

3. The terminal assembly of claim 1 wherein the second base defines an oblong shape.

4. The terminal assembly of claim 1 wherein the female terminal includes an inner surface defining the void having an oblong shape.

5. The terminal assembly of claim 1 wherein:
a first projection of the plurality of projections defines a first length;
a second projection of the plurality of projections defines a second length; and
the second length is less than the first length.

6. The terminal assembly of claim 1 wherein, in the assembled configuration, the male terminal is connected with the female terminal such that the plurality of projections restrict the female terminal from moving relative to the male terminal.

7. The terminal assembly of claim 1 wherein:
the first base is configured for connection with an electrical contact;
the electrical contact is configured for connection with an electrical component; and
in the assembled configuration, the male terminal is electrically connected with the electrical component.

8. The terminal assembly of claim 7 wherein:
the female terminal includes a connection portion connected to the second base and configured for connection with an electrical wire; and
in the assembled configuration:
the electrical wire is electrically connected with an additional electrical component, and
the male terminal is connected with the female terminal such that the electrical component is electrically connected with the additional electrical component.

9. The terminal assembly of claim 1 wherein the oblong shape collectively defined by the plurality of projections is an oval.

10. A vehicle comprising:
the terminal assembly of claim 1;
an electrical component electrically connected with the male terminal; and
an additional electrical component electrically connected with the female terminal,
wherein, in the assembled configuration, the male terminal is connected with the female terminal such that the electrical component is electrically connected with the additional electrical component.

11. A method of assembling a terminal assembly, the method comprising:
disposing at least a portion of a protrusion of a male terminal in a void of a female terminal, the protrusion defining an oblong shape, and a base of the female terminal defining the void; and
engaging a plurality of projections of the female terminal with the protrusion such that the male terminal is electrically connected with the female terminal in an assembled configuration and the plurality of projections are disposed around the void and collectively define an oblong shape.

12. The method of claim 11 wherein a base of the male terminal defines an oblong shape.

13. The method of claim 11 wherein the base of the female terminal defines an oblong shape.

14. The method of claim 11 wherein the female terminal includes an inner surface defining the void having an oblong shape.

15. The method of claim 11 wherein:
a first projection of the plurality of projections defines a first length;
a second projection of the plurality of projections defines a second length; and
the second length is less than the first length.

16. The method of claim 11 wherein, in the assembled configuration, the male terminal is connected with the female terminal such that the plurality of projections restrict the female terminal from moving relative to the male terminal.

17. The method of claim 11 wherein:
a base of the male terminal is configured for connection with an electrical contact;
the electrical contact is configured for connection with an electrical component; and
in the assembled configuration, the male terminal is electrically connected with the electrical component.

18. The method of claim 17 wherein:
the female terminal includes a connection portion connected to the base of the female terminal and configured for connection with an electrical wire; and
in the assembled configuration:
the electrical wire is electrically connected with an additional electrical component, and
the male terminal is connected with the female terminal such that the electrical component is electrically connected with the additional electrical component.

19. The method of claim 11 wherein the oblong shape collectively defined by the plurality of projections is an oval.

20. The method of claim 11 further comprising:
disposing an electrical contact on a glass surface of a vehicle;
connecting an electrical component with the electrical contact; and
securing a base of the male terminal to the electrical contact,
wherein in the assembled configuration the male terminal is electrically connected with the electrical component.
